(19) United States
(12) Patent Application Publication
(10) Pub. No.: US 2009/0111021 A1
(43) Pub. Date: Apr. 30, 2009

(54) HIGH DISCHARGE RATE BATTERIES

(76) Inventors: Rachid Yazami, Los Angeles, CA (US); Qingfang Shi, Pasadena, CA (US)

Correspondence Address: GREENLEE WINNER AND SULLIVAN P C, 4875 PEARL EAST CIRCLE, SUITE 200, BOULDER, CO, 80301, US

(21) Appl. No.: 12/049,147

(22) Filed: Mar. 14, 2008

Related U.S. Application Data
(60) Provisional application No. 60/906,915, filed on Mar. 14, 2007.

(51) Int. Cl. H01M 4/02; H01B 1/04

(52) U.S. Cl. 429/209; 252/500; 252/182.1

(57) ABSTRACT

Improved electrode compositions including fluorinated carbon materials. The electrode compositions can include combinations of subfluorinated carbon materials with more than 10 wt % electrically conducting material. The electrode compositions can also include combinations of subfluorinated carbon materials with a different fluorinated carbon material. These electrode compositions are suitable for use in electrochemical devices such as primary batteries, secondary batteries, and supercapacitors and can provide enhanced performance at high discharge rates compared to conventional CF₁ positive electrode compositions

### CROSS-REFERENCE TO RELATED APPLICATIONS

This application claims the benefit of U. S. Provisional Application No. 60/906,915, filed Mar. 14, 2007, which is hereby incorporated by reference to the extent not inconsistent with the disclosure herein.

### BACKGROUND OF THE INVENTION

Fluorinated carbons are used commercially as a positive electrode material in primary lithium batteries. Fluorination of graphite allows intercalation of fluorine between the carbon layers. Li/CFₓ battery systems are known to be capable of delivery of up to 700 Wh/kg, 1000 Wh/l, at room temperature, and at a rate of C/100 (i.e., a battery current of a 1/100^{th} that of the capacity of the battery per hour). (See, e.g., Bruce, G. Development of a CFₓ D Cell for Man Portable Applications. in Joint Service Power Expo. 2005; and Gabano, J. P., ed. Lithium Batteries, by M. Fukuda & T. lijima. 1983, Academic Press: New York). Cathodes in these systems typically have carbon—fluoride stoichiometries typically ranging from CF_{1.05} to CF_{1.1}. This cathode material, however, is known to be discharge rate limited, and currents lower than C/50 (battery current 1/50^{th} that of the capacity of the battery divided by 1 hour) are often necessary to avoid cell polarization and large capacity loss. High electronic resistivity up to 10¹⁵ Ohm.cm of CFₓ is a potential cause of the observed discharge rate limitations, as there is a strong correlation between cathode thickness and performance; thicker cathodes tend to be more rate-limited. (See, e.g., V. N. Mittkin, J. Structural Chemistry, 2003, Vol. 44, 82-115, translated from Zhurnal Structunoi Khimii, 2003, Vol. 44,99-138).

Other industrial applications of fluorinated carbons include use as solid lubricants or as reservoirs for very active molecular oxidizers such as BrF₃ and CIF₃.

In a lithium/CFₓ cell, the cell overall discharge reaction, first postulated by Wittingham (1975) Electrochem. Soc. 122:526, can be schematized by equation (1):

(CFₓ)ₙ+xnLi [symbol] nC+nxLiF (1)

Thus, the theoretical specific discharge capacity Qₜₕ, expressed in mAh·g−¹, is given by equation (2):

$${Q}_{th} ( x ) = \frac{xF}{3.6 ( 12 + 19 x )} \qquad ( 2 )$$

where F is the Faraday constant and 3.6 is a unit conversion constant.

The theoretical capacity of (CFₓ)n materials with different stoichiometry is therefore as follows: x=0.25, Qₜₕ=400 mAh·g−¹; x=0.33, Qₜₕ=484 mAh g·¹; x=0.50, Qₜₕ=623 mAh·g−¹; x=0.66, Qₜₕ=721 mAh·g−¹; and x=1.00, Qₜₕ=865 mAh·g−¹.

A variety of fluorinated carbonaceous materials have been suggested for use in battery applications. U.S. Pat. No. 3, 536,532 to Watanabe et al. describes a primary cell including a positive electrode having as the principal active material a crystalline fluorinated carbon represented by the formula (CFₓ)ₙ. where x is not smaller than 0.5 but not larger than 1. U.S. Pat. No. 3,700,502 to Watanabe et al. describes a battery including a positive electrode having as its active material an amorphous or partially amorphous solid fluoridated carbon represented by the Formula (CFₓ)ₙ, wherein x is in the range of from greater than 0 to 1. U.S. Pat. No. 4,247,608 to Watanabe et al. describes an electrolytic cell including a positive electrode having as the main active material a poly-dicarbon monofluoride represented by the formula (C₂F)ₙ wherein n is an integer. U.S. Patent Application Publication 2007/0231696 to Yazami et al. describes fluorination of multi-layered fluorinated nanomaterials such as multi-walled nanotubes for incorporation into electrochemical devices. The fluorinated material may contain an unfluorinated and/or “lightly fluorinated” phase. Fluorinated nanotube materials are also described by Chamssedine et al. and Yazami et al. (F. Chamssedine, Reactivity of Carbon Nanotubes with Fluorine GasChem. Mat. 19(2007)161-172; Fluorinated Carbon Nanotubes for High Energy and High Power Densities Primary Lithium Batteries Electrochem. Comm. 9(2007)1850-1855).U.S. Patent Application Publication 2007/0231697 to Yazami et al. describes production of subfluorinated graphite and coke in which the subfluorinated material contains unfluorinated and/or “lightly fluorinated ” phase and use of these materials in electrochemical devices. U.S. Patent Application Publication Nos. 2007/0077495 and US2007/0077493 to Yazami et al. and International Patent Publication WO/2007/040547 also describe production and use of subfluorinated graphite materials.

Electrode compositions incorporating fluorinated carbon materials may also incorporate an electrically conductive material such as carbon black or graphite. U.S. Pat. No. 6,956,018 to Kozawa describes incorporation of 540 wt % of electrically conductive material based on the weight of the active and conducting material into an electrode composition containing polycarbonfluoride (CFₓ)ₙ; the electrode composition is used in combination with a zinc anode and an aqueous alkaline electrolyte. U.S. Pat. No. 5,753,786 to Watanabe et al. describes incorporation of up to 100 wt % of an electrically conductive material (based on the amount of active material) into an electrode composition. The active material is a graphite fluoride obtained by fluorination of a decomposed residual carbon. U.S. Pat. No. 4,247,608 to Watanabe et al. reports electrode compositions incorporating an electrically conductive agent and containing C₂F. Electrode compositions with as little as 25% by weight C₂F are reported.

Electrode compositions combining different fluorinated carbonaceous materials have also been reported. U.S. Pat. Nos. 4,686,161 and 4,765,968 to Shia et al. report elimination of voltage suppression by blending an additive CFₓ which does not show significant voltage suppression with a bulk CFₓ which does show voltage suppression. U.S. Pat. No. 4,681,823 to Tung et al. report mixtures of a fully or overfluorinated CFₓ with a small amount of underfluorinated material to eliminate voltage suppression. U.S. Patent Application US 2007/0281213 to Pyszczek reports blends of fluorinated carbon material which provide an electrochemical cell voltage characteristic that may be used to predict remaining energy capacity as an electrochemical cell discharges during service.

### BRIEF SUMMARY OF THE INVENTION

In different embodiments of the invention, the invention provides electrode compositions including mixtures of different active materials and/or mixtures of active material with a greater than usual amount of electrically conducting material. In an embodiment, the invention provides improved electrode compositions including fluorinated carbon active materials. These electrode compositions are suitable for use in electrochemical devices such as primary batteries, secondary batteries, and supercapacitors. These electrodes can provide enhanced performance at high discharge rates compared to conventional CF₁ positive electrode compositions. As an example, the electrode compositions of the invention are capable of achieving specific power densities beyond those achievable with CF₁.

Fluorinated carbon materials include poly(carbon monofluoride (CF₁) and poly(dicarbon monofluoride) (C₂F). Fluorinated carbon materials also include subfluorinated carbonaceous materials. As used herein, the expression “subfluorinated carbonaceous material” refers to a multicomponent carbonaceous material having a fluorinated carbonaceous component in which at least some of the carbon is strongly bound to fluorine and an unfluorinated carbonaceous component and/or a “lightly fluorinated” carbonaceous component in which fluorine is not strongly bound to carbon. Fluorinated carbon materials also include “fully fluorinated” materials whose fluorine to carbon ratio is about 1. In an embodiment, the fluorinated carbonaceous material is in the form of particles; the particles may be from one micrometer to 100 micrometers in average size.

In an embodiment, the invention provides an electrochemical cell comprising a first electrode comprising an electrode composition of the invention; a second electrode comprising lithium or a lithium alloy; and an electrolyte. In an embodiment, the first electrode composition comprises a subfluorinated carbonaceous material, a carbonaceous electrically conductive material, and a binder and wherein the density of the first electrode composition is greater than about 1.25. In an embodiment, the cell has been pre-treated by discharging up to 10% of the initial capacity of the cell at a discharge rate less than about C/10 for at least one half hour. Typically subsequent discharge of the cell occurs at higher rates.

In one aspect of the invention, the electrode composition includes substantial amounts of an electrically conductive material in addition to the fluorinated carbon active material. In this embodiment, the amount of electrically conductive material is in excess of the 10 wt % typically included in Li/CFₓ batteries (based on total weight of the electrode composition). Suitable electrically conductive materials, include, but are not limited to, carbonaceous materials such as acetylene black, carbon black, powdered graphite, cokes, carbon fibers, and carbon nanotubes. When this electrode composition is used for the cathode of a primary cell, high cell discharge rates can be obtained. In different embodiments, the maximum cell discharge rate is greater than or equal to 1 C, 5 C, 10 C, 25 C, or 50 C. For comparison, conventional discharge rates of Li/CF₁ cells can be on the order of C/50. These electrode compositions can also permit high specific power densities. In an embodiment, the specific power density per weight of active material is greater than or equal to 10 kW/kg, 20 kW/kg, 30 kW/kg, or 40 kW/kg.

In an embodiment, the invention provides an electrode composition comprising a subfluorinated carbonaceous material; and an electrically conducting material wherein the subfluorinated carbonaceous material and the electrically conducting material are intermixed, and the weight % of the electrically conducting material is from 12% to 90%, based on the weight of the electrically conducting and subfluorinated carbon materials. In another embodiment, electrode composition further comprises from 1 wt % to 20 wt % of a binder material and the amount of the electrically conducting material is greater than 10 wt % based on the total weight of the electrode composition. In different embodiments, the fluorination level x is from 0.5 to 0.95, from 0.63 to 0.95, from 0.66 to 0.95, or from 0.7 to 0.95.

In another embodiment the invention provides an electrode comprising a fluorinated carbonaceous material; an electrically conducting material; and a binder material; wherein the fluorinated carbonaceous material, the electrically conducting material and the binder are intermixed, and the weight % of the electrically conducting material is greater than 50% and less than or equal to 90%, based on the weight of the electrically conducting and subfluorinated carbon materials. In another embodiment, the amount of the electrically conducting material is greater than 75%. The fluorinated carbonaceous material may be a subfluorinated material, CFₓ where x is greater than or equal to 1, or C₂F. In an embodiment, the fluorinated carbonaceous material is a subfluorinated material. In another embodiment, the fluorinated material is fully fluorinated.

In another aspect of the invention, the electrode composition includes a mixture of different fluorinated carbon materials. In an embodiment, the different fluorinated carbon materials have different fluorination levels. In another embodiment, the different fluorinated materials may be based on different carbonaceous materials (for example the electrode composition may be a mixture of fluorinated carbon and fluorinated coke, with the fluorinated materials having the same or different fluorination levels). The combination of fluorinated carbon materials may be used to tailor the performance of the device. For example, a fluorinated carbonaceous material that has a relatively high energy density and a relatively low power capability can be blended with a fluorinated carbonaceous material that has a higher power capability to obtain a mixture suitable for relatively high energy density and power density applications. Such blends include blends of CF1 and subfluorinated carbonaceous material and blends of two subfluorinated carbonaceous materials, one with a relatively high ratio of fluorine to carbon.

In an embodiment, the invention provides an electrode composition comprising
a) a first fluorinated carbonaceous material comprising a subfluorinated carbonaceous material; and
b) a second fluorinated carbonaceous material different from the first fluorinated carbonaceous material;

wherein the first and second fluorinated carbonaceous materials are intermixed and the amount of the first material is from 5 wt % to 95 wt % based on the total weight of the first and second materials.

In another embodiment, the electrode composition further comprises an electrically conducting material intermixed with the fluorinated carbonaceous materials, wherein the amount of the electrically conducting material is from 5 wt % to 50 wt % of the total electrode composition. As previously stated, incorporation of higher than usual amounts of electrically conducting material in the electrode composition can increase the maximum discharge rate and/or the maximum specific power density of the electrode composition.

In another aspect of the invention, the invention provides methods for making electrodes having selected energy and power characteristics which employ the electrode compositions of the invention. In different embodiments, the methods of the invention may also employ the electrode densification and pre-discharge techniques described herein. In an embodiment, these methods include the steps of selecting the desired specific energy density of the electrode at a particular specific power density, and then selecting an electrode composition of the invention which meets these specifications. In an embodiment, this electrode composition includes at least one subfluorinated carbonaceous material. In an embodiment, the specified power density is greater than that which is typically achievable with fully fluorinated coke materials.

### BRIEF DESCRIPTION OF THE DRAWINGS

FIG. 1 shows discharge curves obtained with a 120 micrometer thick electrode (not densified) with CF1 active material.

FIG. 2 shows suppression of the voltage delay after cell pre-discharge; the cathode composition includes 50% CF1.

FIG. 3 shows the effect of electrode thickness on discharge curves for a cathode composition with 75% CF1 active material at a discharge rate of 1 C.

FIG. 4 shows the combined effect of a thinner electrode and a 2% pre-discharge at C/30 on the discharge curves obtained for cathode compositions with 75% CF1 active material.

FIG. 5 shows the effect of densification on the discharge curves obtained for a 60-80 micrometer thick cathode (initial thickness) with 75% CF1 active material.

FIG. 6 illustrates the effect of densification on the discharge curves obtained for a 40 micrometer thick cathode with 75% CF1 active material .

FIG. 7 compares the effect of electrode thickness and densification on the Ragone plots for three different cell configurations.

FIG. 8 shows the effect of densification on the discharge curves obtained for cathodes with CF0.744 active material .

FIG. 9 shows a schematic of a three-electrode electrochemical cell used for impedance measurements in a coin cell configuration.

FIG. 10 shows the relevant discharge OCV curve for the impedance measurements.

FIG. 11 shows the impedance Nyquist plots obtained at different states of cell discharge (in %).

FIGS. 12a-12e shows the discharge profiles for cells with the respective cathode compositions: 50% CF: 35% ABG: 15% PVDF, 40% CF: 45% ABG: 15% PVDF; 30% CF: 55% ABG: 15% PVDF; 20% CF: 65% ABG: 15% PVDF; 10% CF: 75% ABG: 15% PVDF.

FIG. 13 shows a Ragone plot of the energy density versus the power density for cathodes with different amounts of CF1 active material. The calculations are based on the amount of pure CF material. The upper x-axis scale is the actual power density in kW/Kg.

FIG. 14 shows a Ragone plot of the energy density versus the power density for cathodes with different amounts of CF1 active material. The calculations are based on the amount of (CF+carbon material). The upper x-axis scale is the actual power density in kW/Kg.

FIG. 15 shows a plot of maximum discharge rate and maximum power density versus the percentage of carbon in the electrode. The power density calculations are based on the amount of (CF+carbon material).

FIG. 16 shows a plot of maximum discharge rate and maximum power density versus the percentage of carbon in the electrode. The power density calculations are based on the amount of CF.

FIG. 17 shows differential discharge capacity versus voltage for an electrode composition with 75% CFx (x=0.647) and no densification. The rechargeable cell has been charged to 5V prior to discharge.

FIG. 18 shows differential capacity versus voltage for a densified electrode composition with 75% CFx (x=0.647). The rechargeable cell has been charged to 4.5V, 4.8V and 5V prior to discharge.

FIG. 19 shows differential capacity versus voltage for a densified electrode composition with 50% CFx (x=0.647). The rechargeable cell has been charged to 4.5V, 4.8V and 5V prior to discharge.

FIG. 20 shows the power profile for the first 24 hours of the wearable power test protocol.

FIG. 21 shows the percent of total energy for each applied discharge power in the wearable power test protocol.

FIG. 22 shows voltage versus time for the cell with a cathode with CF1 active material.

FIG. 23 shows voltage versus time for the cell with a cathode with CFx (x=0.74), active material.

FIG. 24 shows voltage versus time for the cell with the cathode with weight ratio 1:1 mixture of CF1 and CFx (x=0.74), active material.

FIG. 25 shows the average working voltage as a function of time for three different cells: 1: CFx (x=0.74); 2: CF1; 3: CF1: CFx with weight ratio=1:1.

FIG. 26 shows discharge curves at C/20 for four different cells: 1: CF1; 2: CFx (x=0.74), 3: CF1: CFx with weight ratio=2:1, 4: CF1: CFx with weight ratio=1:1.

FIG. 27 shows the discharge curves for a cell with the cathode composition 75% CFx (x=0.76) from fluorinated multi-walled nanotubes.

FIG. 28 shows the discharge curves a cell with the cathode composition 40% CFx (x=0.76) from fluorinated multi-walled nanotubes.

FIG. 29 shows a Ragone plot comparing 75% CFx (x=0.76), 40% CFx (x=0.76) and 40% CF.

### DETAILED DESCRIPTION OF THE INVENTION

The term “electrochemical cell” refers to devices and/or device components that convert chemical energy into electrical energy or electrical energy into chemical energy. Electrochemical cells typically have two or more electrodes (e.g., positive and negative electrodes) wherein electrode reactions occurring at the electrode surfaces result in charge transfer processes. Electrochemical cells include, but are not limited to, primary batteries, secondary batteries, lithium batteries, and lithium ion batteries. General cell and/or battery construction is known in the art, see e.g., U.S. Pat. Nos. 6,489,055, 4,052,539, 6,306,540, Seel and Dahn J. Electrochem. Soc. 147(3) 892-898 (2000). Electrochemical double layer capacitors (EDLC) and hybrid battery-EDLC systems are also considered to be electrochemical cells in this application. (Conway, B, Journal of Solid State Electrochemistry, 7: 637 (2003); Hu X et al. J. Electrochem. Soc., 154 (2007) A1026-A1030 ). The present disclosure also includes combinations of secondary electrochemical cells in series and/or in parallel as batteries and/or supercapacitors.

The term “capacity” is a characteristic of an electrochemical cell that refers to the total amount of electrical charge an electrochemical cell, such as a battery, is able to hold. Capacity is typically expressed in units of ampere-hours. The term “specific capacity” refers to the capacity output of an electrochemical cell, such as a battery, per unit weight. Specific capacity is typically expressed in units of ampere-hours kg⁻¹. The theoretical specific capacity is referred to as Qₜₕ.

The term “discharge rate” refers to the current at which an electrochemical cell is discharged. Discharge current can be expressed in units of amperes. Alternatively, discharge current can be expressed as ‘C/n” rate, where n is the number of hours theoretically needed to fully discharge the cell. For example, under C/5 rate and 3 C rate, the full discharge is expected to be reached in 5 hours and 20 minutes, respectively. Under a constant discharge current of intensity Iₓ, the theoretical discharge time t_{d} is given by Qₜₕ(X)=Iₓt_{d}. Iₓ is the discharge current intensity in units of current per unit weight (e.g. mA/g). Accordingly a discharge current at C/n rate is given by Equation (3):

$${I}_{x} = \frac{{Q}_{th} ( x )}{n} , \qquad ( 3 )$$

Iₓ in mA/g, Qₜₕ(X) in mAh/g and n in hours.

“Current density” refers to the current flowing per unit electrode area.

“Active material” refers to the material in an electrode that takes part in electrochemical reactions which store and/or deliver energy in an electrochemical cell. The present invention provides electrochemical cells having a positive electrode with a fluorinated or subfluorinated carbonaceous active material.

Li/CFₓ batteries can have high energy densities, flat discharge curves and long shelf lives compared to other types of batteries. However, discharge curves of conventional Li/CFₓ batteries display a characteristic voltage delay (also sometimes called voltage suppression) at the initial discharge stage. During this voltage delay, the battery voltage is less than its plateau value. This effect can be suppressed by pre-discharge of a portion (for example, less than or equal to 10%) of the capacity of the battery. In an embodiment, the predischarge procedure involves discharge of no more than 10% of the initial capacity of the cell. In an embodiment, the pre-discharge rate is less than or equal to 5% of the initial capacity of the cell. In different embodiments, the discharge time may be from 0.5 hour to 5 hours or from 1 to 3 hours. In an embodiment, the discharge rate is no greater than C/10. The discharge current may be constant or variable. Therefore, the invention also provides an electrochemical cell after discharge of no more than 10% of the initial capacity of the cell at a rate no greater than C/10 for at least one hour.

In an embodiment, the invention provides an electrochemical device comprising a first electrode and a second electrode, and an ion transporting material disposed therebetween, wherein the first electrode comprises a fluorinated carbonaceous material. In an embodiment, the electrochemical device is an electrochemical cell or battery. In an embodiment, the electrochemical device is predischarged.

The fluorinated carbonaceous materials are normally present in a composition that also includes an electrically conductive material such as may be selected from, for example, acetylene black, carbon black, powdered graphite, cokes, carbon fibers, carbon nanotubes, graphite whiskers and metallic powders such as powdered nickel, aluminum, titanium, and stainless steel. In an embodiment, the electrically conductive material is a carbonaceous material. In an embodiment, the electrical conductivity of this material is greater than that of the fluorinated carbonaceous material. The electrically conductive material may be in particulate form to facilitate its mixture with the other components of the electrode composition. In an embodiment, the particle size of the conductive material is from 1 micrometer to 100 micrometers.

The conductive material improves conductivity of the electrode composition. In one embodiment, the conductive material is present in an amount representing about 1 wt. % to about 10 wt. % of the composition, or about 3 wt. % to about 8 wt. % of the composition. Incorporation of up to 10 wt % conductive material is known to the art.

In another aspect of the invention, the electrode composition comprises significantly larger quantities of an electrically conductive material. Incorporation of such quantities can improve electrode performance at high discharge rates.

In an embodiment, the electrode composition comprises a subfluorinated carbonaceous material and an electrically conducting material wherein the weight % of the electrically conducting material is from 12% to 90%, where the weight percentage is based on the weight of the electrically conducting material divided by the sum of the weight of the electrically conducting material and the fluorinated carbonaceous material. In other embodiments, the amount of the electrically conducting material is from 15 wt % to 85 wt %, from 20 wt % to 80 wt %, from 30 wt % to 70 wt %, or from 40 wt % to 60 wt %, based on the weight of the electrically conducting material and the fluorinated carbonaceous material. In different embodiments, the fluorine to carbon ratio of the subfluorinated carbonaceous material is 0.5-0.95, 0.63-0.95, 0.66-0.95, or 0.7-0.95.

The composition containing the fluorinated carbonaceous materials and the conductive material also typically contains a polymeric binder, with preferred polymeric binders being at least partially fluorinated. Exemplary binders thus include, without limitation, poly(ethylene oxide) (PEO), poly(vinylidene fluoride) (PVDF), a poly(acrylonitrile) (PAN), poly(tetrafluoroethylene) (PTFE), and poly(ethylene-co-tetrafluoroethylene) (PETFE).

In an embodiment, the electrode composition further comprises a binder material in addition to the subfluorinated carbonaceous material and the electrically conducting material. In an embodiment, the amount of the binder material is from 1 wt % to 20 wt % and the amount of the electrically conducting material is greater than 10 wt % based on the total weight of the electrode composition (subfluorinated carbonaceous material, electrically conducting material and binder). In another embodiment, the amount of binder is from 5 wt % to 15 wt % of the total weight of the electrode composition with the balance of the electrode composition. In other embodiments, the amount of electrically conducting material is greater than or equal to 25 wt %, 30 wt %, 40 wt %, 50 wt %, 60 wt %, 70 wt %, or 75 wt % based on the total weight of the electrode composition. The balance of the electrode composition is the subfluorinated material. In different embodiments, the amount of subfluorinated material is from 10 wt % to 80 wt %, from 10 wt % to 70 wt %, from 10 wt % to 60 wt %, from 10 wt % to 50 wt %, from 20 wt % to 70 wt %, or from 30 wt % to 70 wt % based on the total weight of the electrode composition.

In an embodiment, the incorporation of substantial amounts of electrically conductive material can improve the performance of the electrode at high discharge rates. In different embodiments, the maximum cell discharge rate is greater than or equal to 1 C, 2 C, 4 C, 6 C, 10 C, 15 C, 20 C, 30 C, 40 C, 50 C, 60 C, 70 C, 80 C, 90 C, or 100 C. In different embodiments, the specific power density per unit weight of active material and electrically conductive material is greater or equal to 5 kW/kg, 6 kW/kg, 7 kW/kg, 8 kW/kg, 9 kW/kg or 10 kW/kg. In different embodiments the maximum power density per weight of active material and conductive material is greater than or equal to 6 kW/kg, 8 kW/kg,10 kW/kg,12 kW/kg, or 14 kW/kg In an embodiment, the specific power density per weight of active material is greater than or equal to 10 kW/kg, 20 kW/kg, 30 kW/kg, or 40 kW/kg. In different embodiments, the maximum power density per weight of active material is greater than or equal to 10 kW/kg, 20 kW/kg, 30 kW/kg,40 kW/kg, 50 kW/kg , 60 kW/kg or 80 kW/kg.

In another aspect, the invention provides an electrode composition comprising
a) a first fluorinated carbonaceous material comprising a subfluorinated carbonaceous material; and
b) a second fluorinated carbonaceous material different from the first fluorinated carbonaceous material;

wherein the first and second fluorinated carbonaceous materials are intermixed and the amount of the first material is from 5 wt % to 95 wt % based on the total weight of the first and second materials. In different embodiments, the amount of the first material is from 10 wt % to 90 wt %, from 20 wt % to 80 wt %, from 30 wt % to 70 wt %, from 40 wt % to 60 wt %, from 30 wt % to 95 wt %, from 40 wt % to 95 wt %, from 50 wt % to 95 wt %, greater than 50 wt % to 95 wt %, from 60 wt % to 95 wt %, from 70 wt % to 95 wt %, from 40 wt % to 90 wt %, from 50 wt % to 90 wt %, greater than 50 wt % to 90 wt %, from 60 wt % to 95 wt %, from 70 wt % to 90 wt %, based on the total weight of the first and second materials. In different embodiments, the fluorine to carbon ratio of the subfluorinated carbonaceous material is 0.18 to 0.95, 0.33-0.95, 0.36-0.95, 0.5-0.95, greater than 0.5 to 0.95, 0.63-0.95, 0.66-0.95, 0.7-0.95, or 0.7-0.9.

In an embodiment, the electrode composition further comprises a binder material in addition to the fluorinated carbonaceous materials and, if present, electrically conducting material. In an embodiment, the amount of the binder material is from 1 wt % to 20 wt % based on the total weight of the electrode composition (fluorinated carbonaceous materials, electrically conducting material if present and binder). In another embodiment, the amount of binder is from 5 wt % to 15 wt % of the total weight of the electrode composition, with the balance being the fluorinated materials and the electrically conducting materials if present.

In another embodiment, the electrode composition further comprise an electrically conductive material in addition to the fluorinated carbonaceous materials, and, if present, the binder material. In different embodiments, the amount of electrically conductive material is from 5 wt % to 50 wt %, less than or equal to 5 wt %, less than or equal to 10 wt %, greater than 10 wt %, or greater than or equal to 20 wt %, 25 wt %, 30 wt %, 40 wt %, 50 wt %, 60 wt %, 70 wt %, or 75 wt % based on the total weight of the electrode composition. The balance of the electrode composition is the fluorinated materials and the binder if present.

In an embodiment, the invention provides an electrode composition comprising a mixture of a first subfluorinated material whose average ratio of fluorine to carbon is greater than 0.5 with a second fluorinated carbonaceous material whose average ratio of fluorine to carbon is greater than or equal to 1. In this case, addition of the second material can increase the energy density of the mixture as compared to the energy density of the first material under the same discharge conditions. In addition, since the subfluorinated material will typically have better power capability than a fully fluorinated material, the power capability of the mixture can be better than that of the fully fluorinated material. In an embodiment, the amount of the first material is from 40 wt % to 60 wt % with the amount of the second material being from 60 wt % to 40 wt %, based on the total of the two materials. In other embodiments the average ratio of fluorine to carbon for the first material is 0.63-0.95, 0.66-0.95, 0.7-0.95, or 0.7-0.9.

In another embodiment, the invention provides an electrode composition comprising a mixture of at least two subfluorinated materials. In an embodiment, only two subfluorinated materials are blended. In an embodiment, the first material has an average ratio of fluorine to carbon is greater than 0.5 and greater than the average ratio of fluorine to carbon of the second material. In this case, addition of the second material can increase the power density as compared to the power density of the first material under the same discharge conditions. In an embodiment, the amount of the first material is from 60 to 95 wt %, with the amount of the second material being 5% to 40 wt %, based on the total of the two materials. In different embodiments the average ratio of fluorine to carbon for the first material is 0.63-0.95, 0.66-0.95, 0.7-0.95, or 0.7-0.9. In different embodiments, the average ratio of fluorine to carbon for the second material is greater than or equal to 0.18, 0.33, 0.36, 0.5, 0.63, 0.66, or 0.7. In another embodiment, the fluorine level of the first material is 0.7-0.95 and the fluorine level of the second material is 0.33-0.5, with an exemplary composition being 80 wt % of a first material with x=0.85 and 20% of a second material with x=0.36. In this exemplary composition, the x=0.85 material may be fluorinated graphite and the x=0.36 material may be fluorinated coke.

In an embodiment, at a given discharge rate the capacity of the additive material may be greater than that of the original material. If a sufficient amount of the additive is present, the mixture of the two materials can have a greater capacity than the original material (as measured to a selected cut-off voltage). Batteries employing the mixture may also have a longer lifetime than batteries employing the original material for more complicated discharge conditions, such as the wearable power test protocol.

In another aspect of the invention the electrode compositions can include active materials other than carbon fluorides. Such materials include, but are not limited to, anode materials for lithium batteries such as LixC6, LixSi, LixGe, LixSn, LiTiyOz (lithium titanates), anode materials for alkaline batteries such as Zn, cathode materials for primary and rechargeable lithium batteries such as MnO₂, FeS, FeS₂, S (sulfur), AgV₂O_{5.5} (Silver Vanadium Oxide or SVO), LiMO₂ (M=Co, Ni, Mn, Al, Li or a combination thereof), LiMn₂O4, LiMPO₄ ((M=Co, Ni, Mn, Al, Li or a combination thereof) and cathode materials for dry, saline or alkaline zinc batteries such as MnO₂, Ag₂O, AgO. In an embodiment, these materials can be combined with greater than 10 wt % electrically conductive material. In another embodiment, mixtures of these anode materials can be used in electrode compositions. In yet another embodiment, mixtures of these cathode materials with each other and carbon fluorides can be used in electrode compositions. These mixtures may also be combined with greater than 10% of an electrically conductive material. These electrode compositions may also be densified before use, and cells incorporating these electrode compositions pre-discharged before use.

Typically, a slurry is formed upon admixture of the fluorinated carbonaceous material(s), conductive material (if present) and binder (if present) with a solvent. This slurry is then deposited or otherwise provided on a conductive substrate to form the electrode. If the fluorinated particles are elongated, they may be at least partially aligned during the deposition process. For example, shear alignment may be used to align the subfluorinated particles. A particularly preferred conductive substrate is aluminum, although a number of other conductive substrates can also be used, e.g., stainless steel, titanium, platinum, gold, and the like.

The solvent may then be evaporated from the slurry, forming a thin film of the electrode composition. This thin film may be processed to the desired density. Suitable methods for processing the electrode composition include a variety of methods for transferring mechanical energy including, but not limited to, pressing, stamping, embossing, or rolling of the film. The electrode composition may also be heated during processing. The processing time is also an important factor influencing the final density. In different embodiments, the final density of the film after processing is greater than 1.0 g/cm³, greater than or equal to 1.25 g/cm³, or greater than or equal to 1.5 g/cm³. The thickness of the electrode may be adjusted as required for the particular application. For applications requiring higher power density, it may be desirable to use thinner electrodes. Density is calculated using the formulae:

$$d = \frac{4 m}{π {D}^{2} h} \qquad ( 4 )$$

where m=weight of the cathode disc in grams, D=diameter of the cathode (film or pellet) in centimeters and h=electrode thickness in centimeters.

In a primary lithium battery, for example, the aforementioned electrode serves as the cathode, with the anode providing a source of lithium ions, wherein the ion-transporting material is typically a microporous or nonwoven material saturated with a nonaqueous electrolyte. The anode may comprise, for example, a foil or film of lithium or of a metallic alloy of lithium (LiAl, for example), or of carbon-lithium, with a foil of lithium metal preferred. The ion-transporting material comprises a conventional “separator” material having low electrical resistance and exhibiting high strength, good chemical and physical stability, and overall uniform properties. Preferred separators herein, as noted above, are microporous and nonwoven materials, e.g., nonwoven polyolefins such as nonwoven polyethylene and/or nonwoven polypropylene, and microporous polyolefin films such as microporous polyethylene, Poly(tetrafluoro)ethylene (PTFE) and glass fibers. An exemplary microporous polyethylene material is that obtained under the name Celgard.RTM. (e.g., Celgard.RTM. 2400, 2500, and 2502) from Hoechst Celanese. The electrolyte is necessarily nonaqueous, as lithium is reactive in aqueous media. Suitable nonaqueous electrolytes are composed of lithium salts dissolved in an aprotic organic solvent such as propylene carbonate (PC), ethylene carbonate (EC), ethyl methyl carbonate (EMC), dimethyl ether (DME), and mixtures thereof. Mixtures of PC and DME are common, typically in a weight ratio of about 1:3 to about 2:1. Suitable lithium salts for this purpose include, without limitation, LiBF.sub.4, LiPF.sub.6, LiCF.sub.3SO.sub.3, LiClO.sub.4, LiAlCl.sub.4, and the like. It will be appreciated that, in use, a change in voltage causes generation of lithium ions at the anode and migration of the ions through the electrolyte-soaked separator to the subfluorinated carbonaceous material of the cathode, “discharging” the battery.

Low temperature electrolytes have been referenced in by Whitacre et al. (Low Temperature Li-CFₓ Batteries Based on Sub-Fluorinated Graphitic Materials J. Power Sources 160(2006)577-584; Enhanced Low-Temperature Performances of Li-CFₓ Batteries Electrochem. Solid State Let. 10 (2007) A166-A170).

In an embodiment, the invention provides an electrochemical device wherein the device is a primary lithium battery in which the first electrode acts at the cathode, the second electrode acts at the anode and comprises a source of lithium ions, and the ion-transporting material physically separates the first and the second electrode and prevents direct electrical contact therebetween.

In another embodiment, the fluorinated carbonaceous material is utilized in a secondary battery, i.e., a rechargeable battery such as a rechargeable lithium battery. In such a case, the cations, e.g., lithium ions, are transported through a solid or a gelled polymer electrolyte—which also serves as a physical separator—to the subfluorinated electrode, where they are intercalated and de-intercalated by the subfluorinated material. Examples of solid polymer electrolytes include chemically inert polyethers, e.g., poly(ethylene oxide) (PEO), poly(propylene oxide) (PPO), and other polyethers, wherein the polymeric material is impregnated or otherwise associated with a salt, e.g., a lithium salt such as those set forth in the preceding paragraph. Examples of gelled polymer electrolytes include polyvinylene difluoride (PVDF) homo- or co-polymer impregnated or otherwise associated with a non-aqueous electrolyte such as those set forth in the preceding paragraph.

In another embodiment, the invention provides an electrochemical device, wherein the device is a secondary battery in which the second electrode comprises a source of ions of a metal selected from Groups 1, 2, and 3 of the Periodic Table of Elements and the ion-transporting material comprises a solid polymer electrolyte that permits transport of said metal cations and physically separates the first and second electrodes.

In still a further aspect of the invention, a rechargeable battery is provided that includes: a first electrode comprising a subfluorinated carbonaceous material, the electrode capable of receiving and releasing cations of a metal selected from Groups 1, 2, and 3 of the Periodic Table of the Elements; a second electrode comprising a source of the metal cations; and a solid or a gelled polymer electrolyte that permits transport of the metal cations and physically separates the first and second electrodes.

In another embodiment, the invention provides an electrochemical device wherein the device is a supercapacitor. An electrochemical supercapacitor is an electrical storage device comprising electrodes and an electrolyte, which is typically capable of high charge and discharge rates. A supercapacitor is an electrical energy storage cell in which ions are stored on or near the surfaces of the electrodes. Associated with each stored ion is a stored electric charge (an electron or a hole) that neutralizes the total charge at the surface of an electrode; charges are typically stored in a “double layer” at the electrode/electrolyte interface. Accordingly, supercapacitors are also referred to as electrochemical double-layer capacitors. On discharge, ions stored at the surfaces migrate into the electrolyte and the associated electric charges are released to an external circuit, thereby providing an electric current. Compared to batteries, supercapacitors typically store less energy per weight, but typically charge and discharge in much shorter time scales. Electrochemical supercapacitor electrodes typically use high active-surface-area materials, for example, carbons and metal oxides.

As used herein, a fluorinated carbonaceous material is a carbonaceous material into which fluorine has been introduced. In the present invention, this fluorination will typically involve formation of bonds between carbon and fluorine. Fluorine is capable of forming both ionic and covalent bonds with carbon. In some cases, C—F bonds have also been classified as intermediate in strength between ionic and covalent bonds (e.g. partially ionic, semi-ionic, semi-covalent). The fluorination method can influence the type of bonding present in the fluorination product.

The average ratio of fluorine to carbon (F/C) may be used as a measure of the extent or level of fluorination. This average ratio may be determined through weight uptake measurements or through quantitative NMR measurements. When fluorine is not uniformly distributed through the wall thickness of the carbon material, this average ratio may differ from surface fluorine to carbon ratios as may be obtained through x-ray photoelectron spectroscopy (XPS) or ESCA. In some embodiments, the average ratio of fluorine to carbon (F/C) may be greater than or equal to 1. The term CF1 or CF may be used herein to refer to fluorinated carbon with a nominal fluorine to carbon ratio of about 1 or greater.

In an embodiment, the carbonaceous material is subfluorinated and includes an unfluorinated carbonaceous component and/or a “lightly fluorinated” carbonaceous component in which fluorine is not strongly bound to carbon. Multiphase subfluorinated carbonaceous materials may comprise a mixture of carbonaceous phases including, an unfluorinated carbonaceous phase (e.g., graphite or coke), a “lightly fluorinated” phase and one or more fluorinated phases (e.g., poly(carbon monofluoride (CF₁); poly(dicarbon monofluoride) etc.). In an embodiment, subfluorinated graphite or coke materials are produced by the methods described in U.S. Patent Application Publication 20070231697 to Yazami et al. and retain a greater amount of unfluorinated carbon, “lightly fluorinated” carbon, or a combinations thereof than materials of the same average F/C ratio produced with other types of fluorination processes previously known to the art. In different embodiments, the subfluorinated material has an average chemical composition CFx in which 0.18≦x≦0.95, 0.33≦x≦0.95, 0.36≦x≦0.95, 0.5<x≦0.95, 0.63≦x≦0.95, 066≦x≦0.95, 0.7≦x≦0.95; or 0.7≦x≦0.9. In an embodiment, the subfluorinated graphite materials have a fluorine to carbon ratio greater than 0.63 and less than or equal to 0.95. In different embodiments, the amount of unfluorinated and “lightly fluorinated” carbon in the subfluorinated material is between 5% and 40%, between 5% and 37%, between 5% and 25%, between 10% and 20%, or about 15%.

In an embodiment, the subfluorinated carbonaceous material is a subfluorinated graphite material having an average chemical composition CFₓ in which 0.63<x≦0.95, wherein ¹³C nuclear magnetic resonance spectroscopy analysis of the subfluorinated graphite provides a spectrum comprising at least one chemical shift peak centered between approximately 100 and 150 ppm relative to TetraMethylSilane (TMS) and another chemical shift peak centered at approximately 84-88 ppm relative to TMS.

In an embodiment, the subfluorinated carbonaceous material is a subfluorinated coke material prepared by direct fluorination of coke having a coherence length L_{c} between 5 nm and 20 nm, the subfluorinated coke material having an average chemical composition CFₓ in which 0.63<x≦0.95. ¹³C nuclear magnetic resonance spectroscopy analysis of the subfluorinated coke provides a spectrum comprising at least one chemical shift peak centered between approximately 100 and 150 ppm relative to TetraMethylSilane (TMS) and another chemical shift peak centered at approximately 84-88 ppm relative to TMS.

In another embodiment, the subfluorinated material is a fluorinated carbon nanomaterial as described in U.S. Patent Application Publication 2007/0231696 to Yazami et al. These fluorinated carbon nanomaterials may comprise an unfluorinated carbon phase and at least one fluorinated carbon product in which at least some of the carbon is covalently bound or nearly covalently bound to fluorine, wherein the carbon nanomaterial has a substantially ordered multi-layered structure prior to fluorination. In different embodiments, the average ratio of fluorine to carbon is between 0.06 and 0.68, between 0.3 and 0.66 or between 0.3 and 0.6.

In another embodiment, the fluorinated carbon nanomaterial may comprise at least one fluorinated carbon product in which at least some of the carbon is covalently bound or nearly covalently bound to fluorine and in which the average interlayer spacing is intermediate between that of graphite poly(dicarbon monofluoride) and that of graphite poly(carbon monofluoride), wherein the carbon nanomaterial has a multi-layered structure prior to fluorination. In different embodiments, the average fluorine to carbon ratio is less than 1.0, between 0.3 and 0.8 or between 0.6 and 0.8, between 0.39 and 0.95, between 0.39 and 0.86, between 0.39 and 0.68, between 0.68 and 0.86, or between 0.74 and 0.86.

In an embodiment, the fluorinated carbon nanomaterial has some characteristics similar to those which would be produced by a mixture of graphite fluorides (C₂F), and (CF)ₙ. X-ray diffraction analysis shows this product to have 2Θ peaks centered at 12.0 degrees and 41.5 degrees. The interlayer spacing of this compound is approximately 0.72 nm. ¹³C—NMR spectra of this compound have a resonance present at 42 ppm, which indicates non-fluorinated Sp3 carbon atoms. NMR analysis also indicates covalent bonding between carbon and fluorine. CF₂ and CF₃ groups may also be present in minor amounts. Another fluorinated carbon product can have structural similarities to (CF)ₙ. X-ray diffraction analysis shows this compound to have 2Θ peaks centered at greater than 12.0 degrees and less than 41.5 degrees . The interlayer spacing of this compound is approximately 0.60 nm. NMR analysis also indicates at covalent bonding between carbon and fluorine. CF₂ and CF₃ groups may also be present in minor amounts.

A range of carbonaceous materials are useful for fluorinated materials in electrodes of the present invention including graphite, coke, and carbonaceous nanomaterials, such as multiwalled carbon nanotubes, carbon nanofibers, multi-layered carbon nanoparticles, carbon nanowhiskers and carbon nanorods. In an embodiment, the invention uses subfluorinated carbonaceous materials obtained through direct fluorination of graphite or coke particles or carbon nanomaterials. Subfluorinated carbonaceous materials obtained through fluorination of graphite particles may also be referred to as subfluorinated graphites or subfluorinated graphite materials herein. Similarly, subfluorinated carbonaceous materials obtained through fluorination of coke particles may also be referred to as subfluorinated cokes or subfluorinated coke materials herein.

The reactivity of carbon allotropic forms with fluorine gas differs largely owing either to the degree of graphitization or to the type of the carbon material (Hamwi A. et al.; J. Phys. Chem. Solids, 1996, 57(6-8), 677-688). In general, the higher the graphitization degree, the higher the reaction temperature. Carbon fluorides have been obtained by direct fluorination in the presence of fluorine or mixtures of fluorine and an inert gas. When graphite is used as the starting material, no significant fluorination is observed below 300° C. From 350 to 640° C., two graphite fluorides, mainly differing in crystal structure and composition are formed: poly(dicarbon monofluoride) (C₂F)ₙ and poly(carbon monofluoride) (CF)ₙ (Nakajima T.; Watanabe N. Graphite fluorides and Carbon-Fluorine compounds, 1991, CRC Press, Boston; Kita Y.; Watanabe N.; Fujii Y.; J. Am. Chem. Soc., 1979, 101,3832). In both compounds the carbon atoms take the Sp3 hybridization with associated distortion of the carbon hexagons from planar to ‘chair-like’ or ‘boat-like’ configuration. Poly(dicarbon monofluoride) is obtained at ˜350° C. and has a characteristic structure, where two adjacent fluorine layers are separated by two carbon layers bonded by strongly covalent C-C bonding along the c-axis of the hexagonal lattice (stage 2). On the other hand, poly(carbon monofluoride) which is achieved at ˜600° C. has a structure with only one carbon layer between two adjacent fluorine layers (stage 1). Graphite fluorides obtained between 350 and 600° C. have an intermediary composition between (C₂F)ₙ and (CF)ₙ and consist of a mixture of these two phases (Kita, 1979, ibid.). The stage s denotes the number of layers of carbon separating two successive layers of fluorine. Thus a compound of stage 1 has a sequence of stacking of the layers as FCF/FCF . . . and a compound of stage 2 has the sequence FCCF/FCCF . . . Both poly(dicarbon monofluoride) and poly(carbon monofluoride) are known to have relatively poor electrical conductivity. Subfluorinated carbonaceous materials include carbonaceous materials exposed to a fluorine source under conditions resulting in incomplete or partial fluorination of a carbonaceous starting material. Partially fluorinated carbon materials include materials in which primarily the exterior portion has reacted with fluorine while the interior region remains largely unreacted.

Carbon-fluorine intercalation compounds have been also obtained by incorporating other compounds capable of acting as a fluorination catalyst, such as HF or other fluorides, into the gas mixture. These methods can allow fluorination at lower temperatures. These methods have also allowed intercalation compounds other than (C₂F)ₙ and (CF)ₙ to be prepared (N. Watanabe et al., “Graphite Fluorides”, Elsevier, Amsterdam, 1988, pp 240-246). These intercalation compounds prepared in the presence of HF or of a metal fluoride have an ionic character when the fluorine content is very low (F/C<0. 1), or an iono-covalent character for higher fluorine contents (0.2<F/C<0.5). In any case, the bonding energy measured by Electron Spectroscopy for Chemical Analysis (ESCA) gives a value less than 687 eV for the most important peak of the F₁ₛ line and a value less than 285 eV for that of the C₁ₛ line (T. Nakajima, Fluorine-carbon and Fluoride-carbon, Chemistry, Physics and Applications, Marcel Dekker 1995 p.13).

In an embodiment, the subfluorinated carbonaceous materials used in the invention are multicomponent materials having a fluorinated carbonaceous component and an unfluorinated carbonaceous component and/or a “lightly fluorinated” carbonaceous component in which fluorine is not strongly bound to carbon. The presence of an unfluorinated and/or a “lightly fluorinated” carbonaceous component can provide higher electrical conductivity than would be obtained for a material consisting solely of the fluorinated phases poly(dicarbon monofluoride), poly(carbon monofluoride) and combinations thereof.

In an embodiment, the subfluorinated carbonaceous material comprises a plurality of nanostructured particles; wherein each of the nanostructured particles comprise a plurality of fluorinated domains and a plurality of unfluorinated domains. In the context of this description a “domain” is a structural component of a material having a characteristic composition (e.g., unfluorinated or fluorinated), phase (e.g., amorphous, crystalline, C.sub.2F, CF.sub.1, graphite, coke, carbon fiber, carbon nanomaterials such as multiwalled carbon nanotube, carbon whisker, carbon fiber etc.), and/or morphology. Useful subfluorinated carbonaceous materials for positive electrode active materials comprise a plurality of different domains. Individual fluorinated and unfluorinated domains preferably for some applications have at least one physical dimension (e.g., lengths, depths, cross sectional dimensions etc.) less than about 50 nanometers, and more preferably for some applications at least one physical dimension less than about 10 nanometers. Positive electrode active materials particularly useful for electrochemical cells providing high performance at low temperatures include nanostructured particles having fluorinated domains and unfluorinated domains that are distributed throughout each nanostructured particle of the active material, and in some embodiments substantially uniformly distributed throughout each nanostructured particle of the active material. In some embodiments, fluorinated domains of particles of the positive electrode active material comprise a subfluorinated carbonaceous material having an average stoichiometry CFy, wherein y is the average atomic ratio of fluorine atoms to carbon atoms and is selected from the range of about 0.8 to about 0.9, and the unfluorinated domains of the particles of the positive electrode active material comprise a unfluorinated carbonaceous phase, such as graphite, coke, multiwalled carbon nanotubes, multi-layered carbon nanofibers, multi-layered carbon nanoparticles, carbon nanowhiskers and carbon nanorods.

“Room temperature” refers to a temperature selected over the range of about 293 to 303 degrees Kelvin.

The invention may be further understood by the following non-limiting examples.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim. When a compound is claimed, it should be understood that compounds known in the art including the compounds disclosed in the references disclosed herein are not intended to be included. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials, and synthetic methods, other than those specifically exemplified can be employed in the practice of the invention without resort to undue experimentation. All art-known functional equivalents, of any such methods, device elements, starting materials, and synthetic methods are intended to be included in this invention.. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The preceding definitions are provided to clarify their specific use in the context of the invention.

Although the description herein contains many specificities, these should not be construed as limiting the scope of the invention but as merely providing illustrations of some of the presently preferred embodiments of the invention. For example, thus the scope of the invention should be determined by the appended claims and their equivalents, rather than by the examples given.

### EXAMPLE 1

### Effects Of Predischarge And Electrode Densification For Electrodes With CF1 and CFX (x=0.744) Active Materials

The carbon fluorides used were a fluorinated coke from Lodestar PC10 product (petroleum coke CF1) and CFx (x=0.744, from graphite). 2016-type coin cells were made, comprising a CF cathode and a metallic lithium anode . For a typical cathode composition CF1/CFx powder and Acetylene Black Graphite (ABG) and PVDF binder were mixed at a weight ratio 75:10:15 in acetone solution for 2 hours. The mixture solution was evaporated in air and a thin film was obtained with the thickness at around 120 μm. Films were also made by a similar technique with a thickness around 60˜80 μm. Some of the 60˜80 μm films were densified via stamping to a thickness of approximately 35 μm. The initial density of the undensified films was approximately 0.8 +/−0.1 g/cm³, while the density of the densified films was approximately 1.6+/−0.1 g/cm³. The thin film was cut to 10 mm in diameter electrodes and dried at 100° C. overnight in vacuum. In the test cells, a Celgard 2400 separator was placed between the CF cathode and Li anode. The electrolyte was 1 M LiBF4 in EC/DME (1:1).

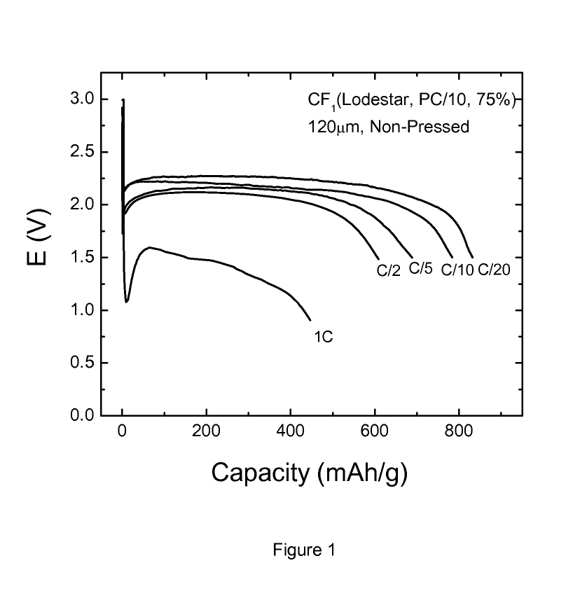

FIG. 1 shows discharge curves obtained with a 120 micrometer thick electrode (not densified) with CF1 active material (Lodestar, PC/10, 75%). In this cell configuration the fastest acceptable discharge rate was C/2; the 1 C rate gives poor performance.

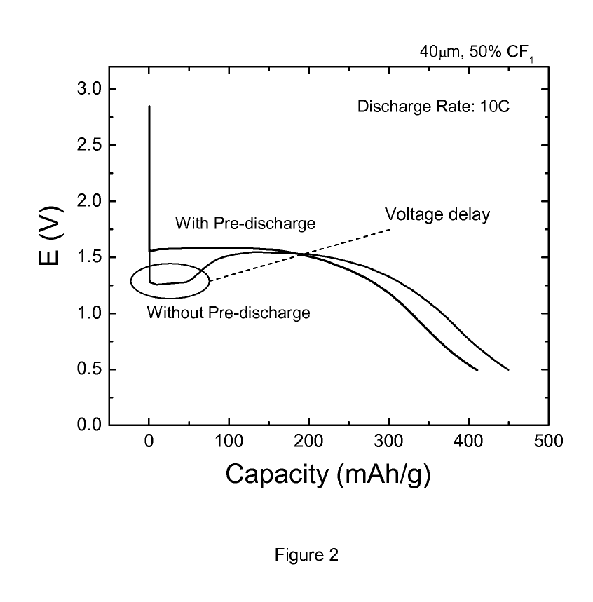

FIG. 2 shows suppression of the voltage delay after cell pre-discharge; the cathode composition includes 50% CF1 active material. The voltage delay effect at a 10 C discharge rate was suppressed by a pre-discharge of 2% of the capacity of the cell at a low discharge rate.

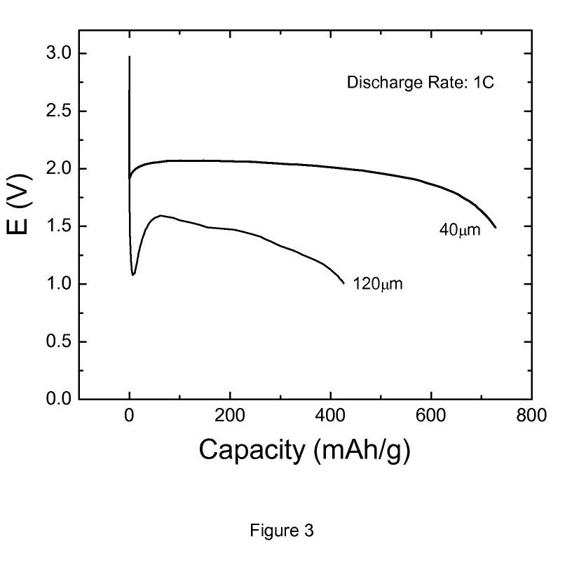

FIG. 3 shows the effect of electrode thickness on discharge curves for a cathode composition with 75% CF1 active material at a discharge rate of 1 C. The cell with the thinner electrode had 2.7 times the energy of the cell with the thicker electrode.

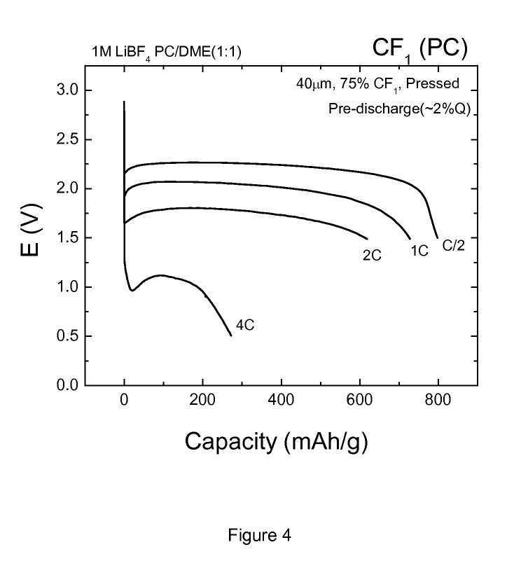

FIG. 4 shows the combined effect of the thinner electrode and a 2% pre-discharge at C/30 on the discharge curves obtained for cathode compositions with 75% CF1 active material. The fastest rate went up to 4 C (4 times that of the thicker electrode with no predischarge).

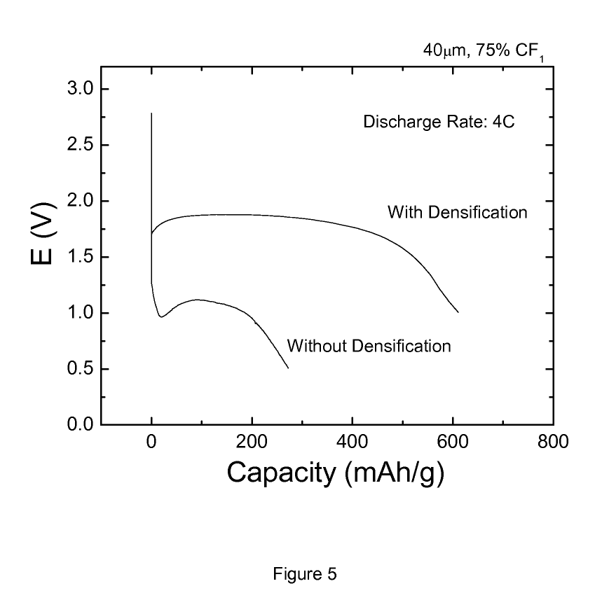

FIG. 5 shows the effect of densification on the discharge curves obtained for a 60˜80 micrometer thick cathode (initial thickness) with 75% CF1 active material. The discharge rate was 4 C. The cell with the densified electrode had 4.5 times the energy of the cell with the non-densified electrode.

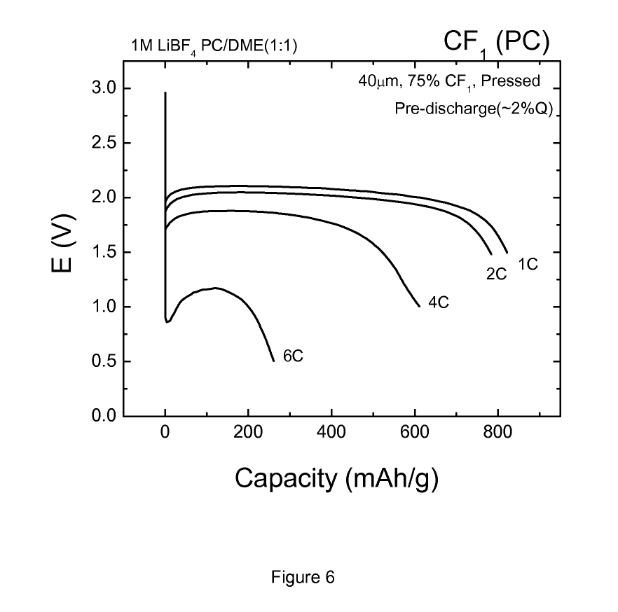

FIG. 6 illustrates the effect of densification on the discharge curves obtained for a 40 micrometer thick cathode with 75% CF1 active material. The fastest discharge rate was 6 C (1.5 times that of the cell with the undensified electrode).

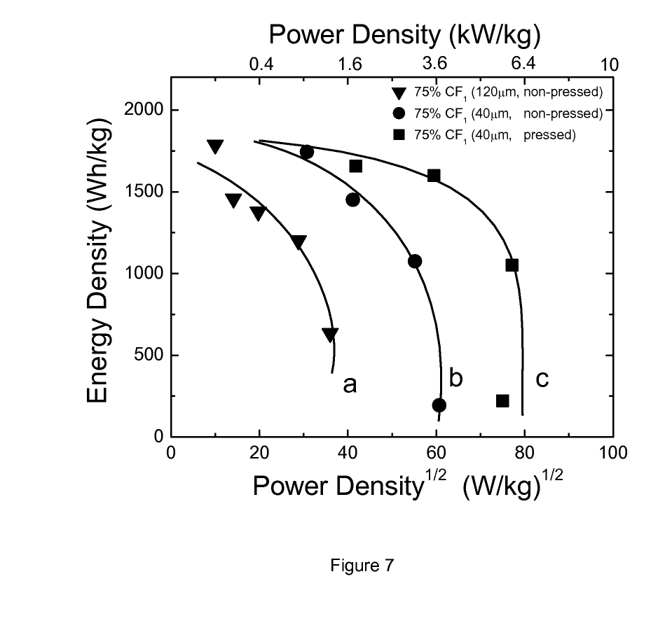

FIG. 7 compares the effect of electrode thickness and densification on the Ragone plots for three different cell configurations. Curve a) shows results for 120 micrometer thick CF electrodes, curve b ) shows results for 40 micrometer CF electrodes, curve c) shows results for densified 40 micrometer CF electrodes. Fast discharge behavior improved when the electrode thickness decreased, and improved further when an impulse pressure was applied to the electrode to densify it. The power density increased 4 times from a thick 120 μm to a thin 40μm pressed electrode.

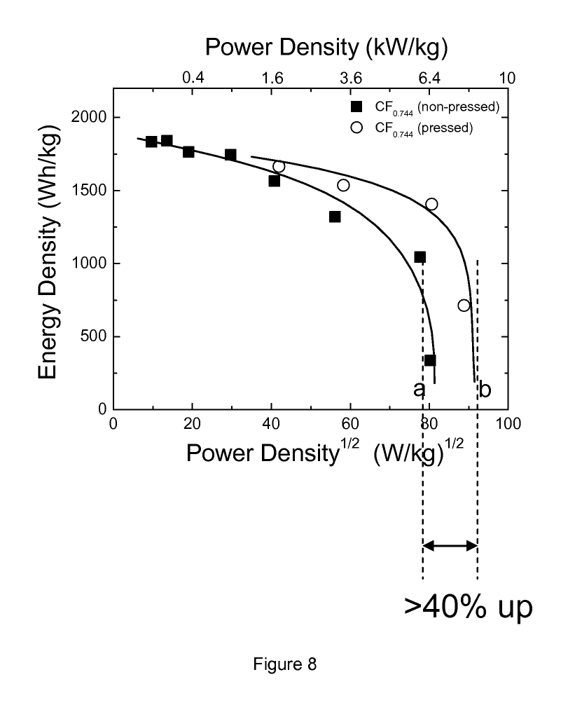

FIG. 8 shows the effect of densification on the discharge curves obtained for cathodes with CF0.744 active material. The power density increased as much as about 40%.

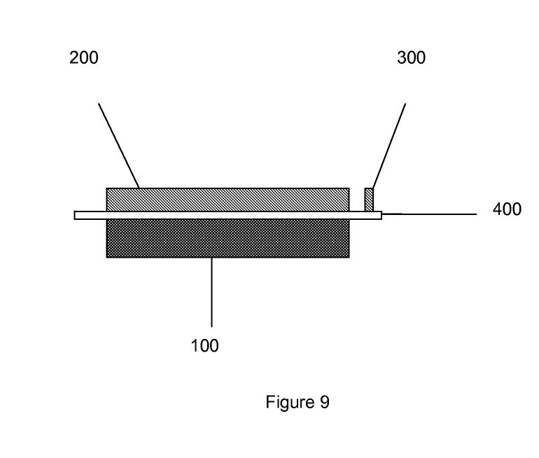

The effect of varying amounts of predischarge on the cell impedance was measured using a three-electrode electrochemical cell using a coin cell configuration (FIG. 9). Thee working electrode (100) was CF0.74 with ABG and PVDF (weight ratio: 75:10:15), the counter electrode (200) was Li foil, and the reference electrode (300) was Li foil. The electrolyte was 1 M LiBF4 in PC/DME (1:1). The separator (400) was porous PTFE film. The frequency range was 100kHz-0.1 Hz. The AC signal amplitude was 10 mV. The cell was discharged at C/10 rate for each discharge stage from 3% to 90%. After each discharge stage, the cell rested for one day. Impedance spectra were measured after each discharge stage on rested cells.

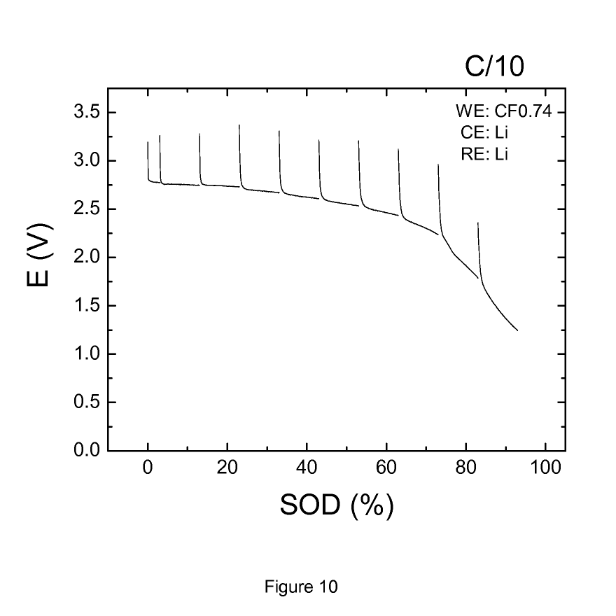

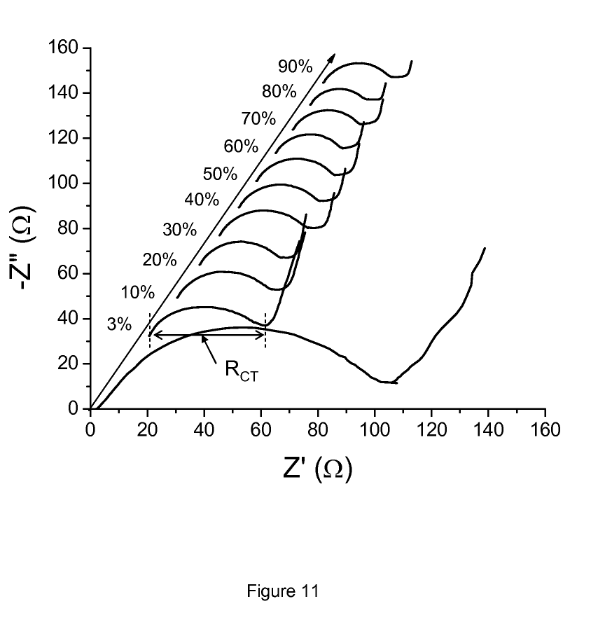

FIG. 10 shows the relevant discharge OCV curve for the impedance measurements. Measurements were taken after discharge of 3%, 10%, 20%, 30%, 40%, 50%, 60%, 70%, 80%, and 80%. FIG. 11 shows the Nyquist plots obtained for different states of cell discharge (in %). After only 3% pre-discharge the charge transfer resistance RCT decreased 2.66 times and then slowly deceased with the state of discharge (SOD) up to 90%.

### EXAMPLE 2

### Effect Of Carbon Dilution For Electrodes With Fluorinated Carbon Active Material

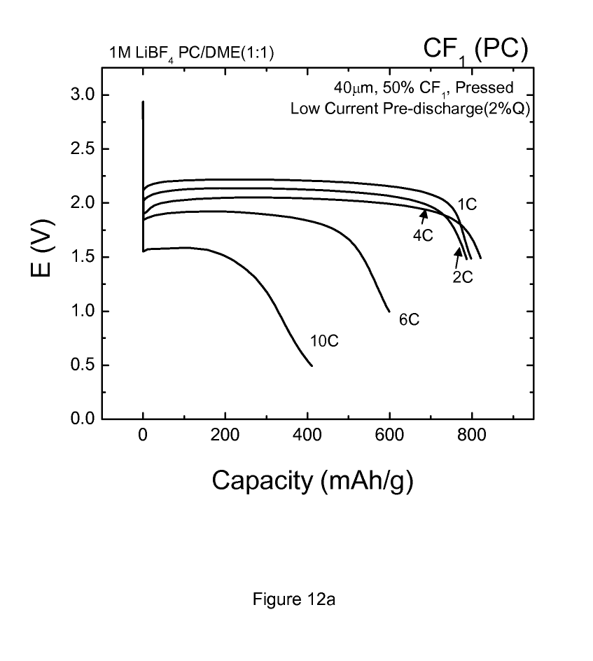

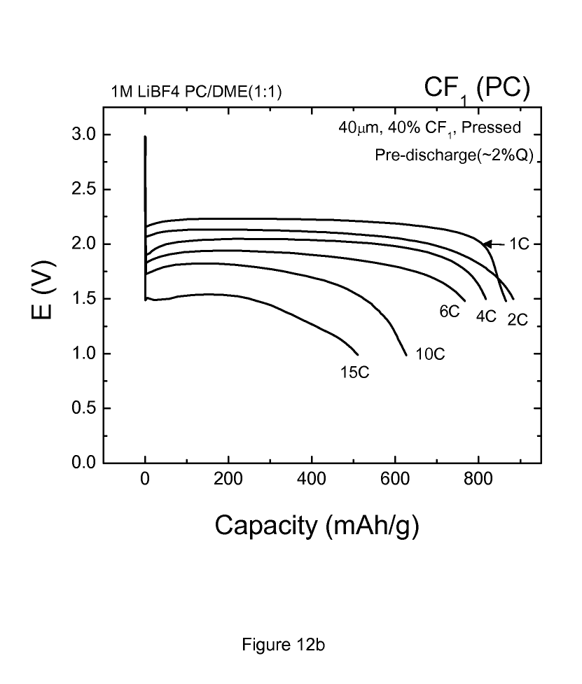

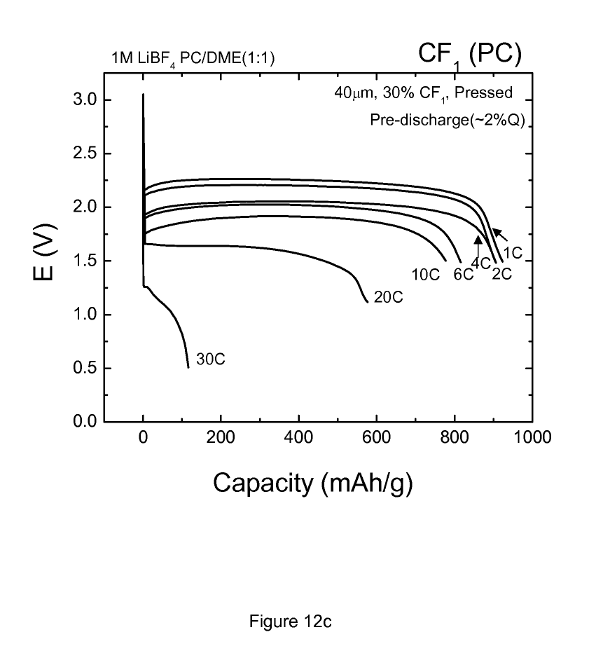

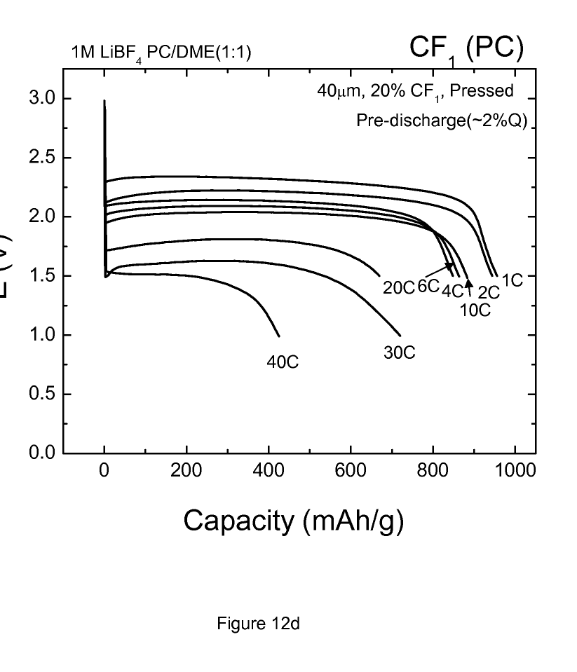

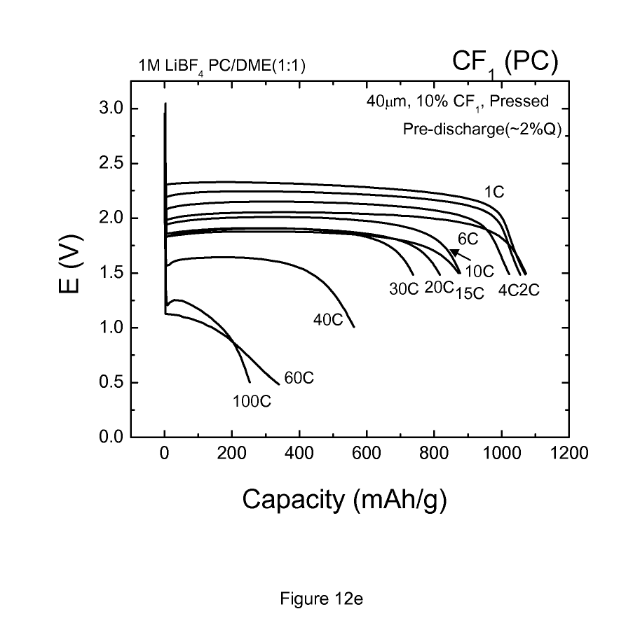

A series of diluted CF electrodes were made by the addition of ABG while keeping the total weight and thickness the same. The CF1 was commercial carbon monofluoride (from coke). All electrodes were made at 40 μm, impulse-pressed, and 2% predischarged before the tests. Unexpectedly large increases were found in the maximum discharge rates and the specific power densities with increasing concentrations of electrically conductive material. In the discharge curves of FIGS. 12a-12e, the capacity is calculated based on the weight of active material

FIG. 12a shows the discharge profile for a cell with a cathode composition: 50% CF: 35% ABG: 15% PVDF (approximately 41 wt % ABG based on the total weight of conductive and active material).

FIG. 12b shows the discharge profile for a cell with a cathode composition: 40% CF: 45% ABG: 15% PVDF (approximately 53 wt % ABG based on the total weight of conductive and active material).

FIG. 12c shows the discharge profile for a cell with a cathode composition: 30% CF: 55% ABG: 15% PVDF (approximately 65 wt % ABG based on the total weight of conductive and active material).

FIG. 12d shows the discharge profile for a cell with a cathode composition: 20% CF: 65% ABG: 15% PVDF (approximately 76 wt % ABG based on the total weight of conductive and active material).

FIG. 12e shows the discharge profile for a cell with a cathode composition: 10% CF: 75% ABG: 15% PVDF (approximately 88 wt % ABG based on the total weight of conductive and active material). A discharge rate as high as 100 C could be reached in this cell.

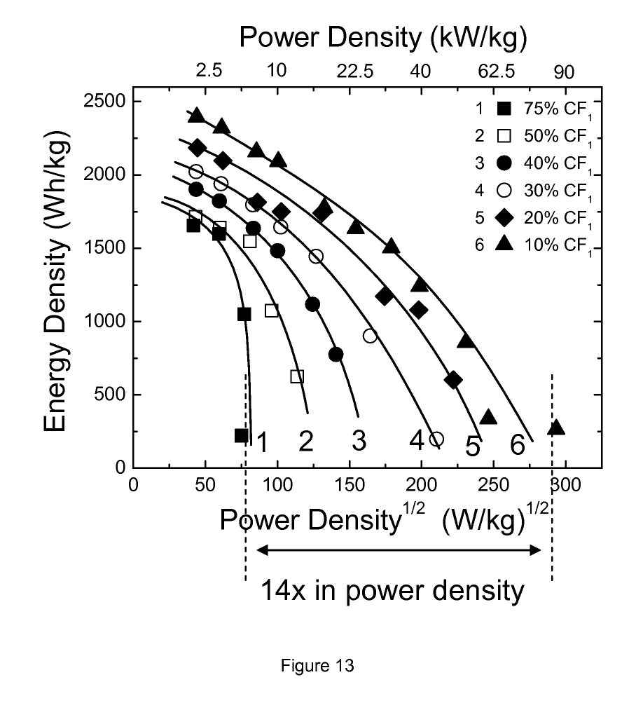

FIG. 13 shows a Ragone plot of the energy density versus the power density for cathodes with different amounts of CF1 active material. The calculations are based on the amount of pure CF material, so that the power density and energy density are per kilogram of CF material. Curve 1: 75% CF; Curve 2: 50% CF; Curve 3: 40% CF; Curve 4: 30% CF; Curve 5: 20% CF; Curve 6: 10% CF. The power density of the most dilute material is as high as 14 times the power density of CF.

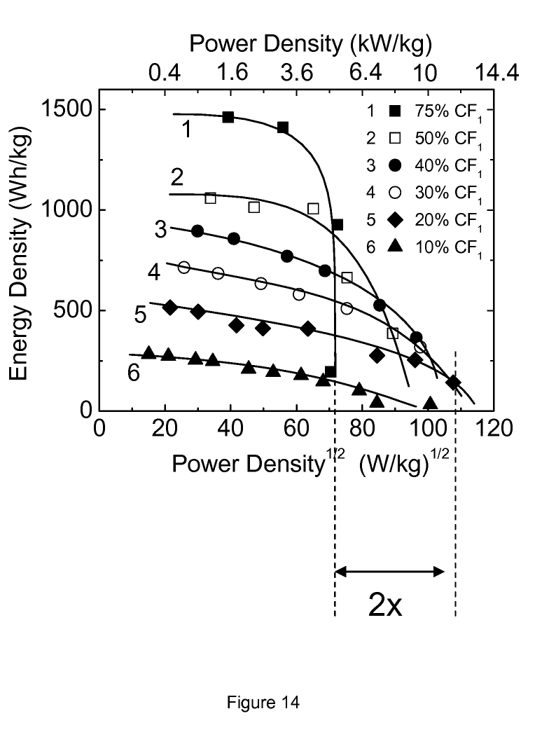

FIG. 14 shows a Ragone plot of the energy density versus the power density for cathodes with different amounts of CF1 active material. The calculations are based on the amount of ( CF+carbon) material, so that the power density and energy density are per kilogram of CF+carbon. Curve 1: 75% CF; Curve 2: 50% CF; Curve 3: 40% CF; Curve 4: 30% CF; Curve 5: 20% CF; Curve 6: 10% CF. The power density of the most dilute material is as high as 2 times the power density of CF.

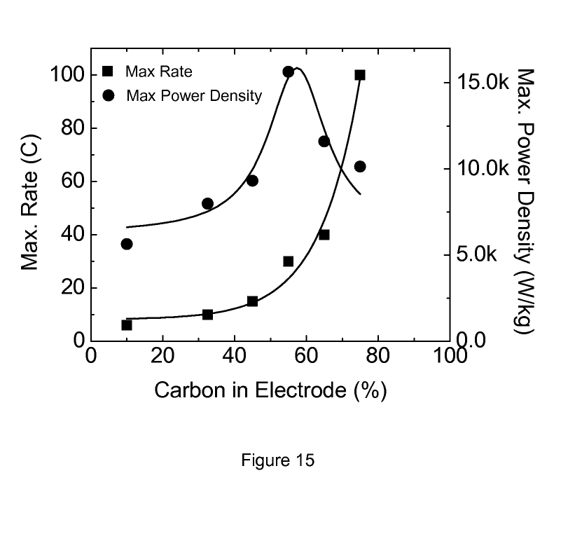

FIG. 15 shows a plot of maximum discharge rate and maximum power density versus the percentage of carbon in the electrode. The power density calculations are based on the amount of (CF+carbon material). The maximum power was obtained at approximately 50% carbon dilution.

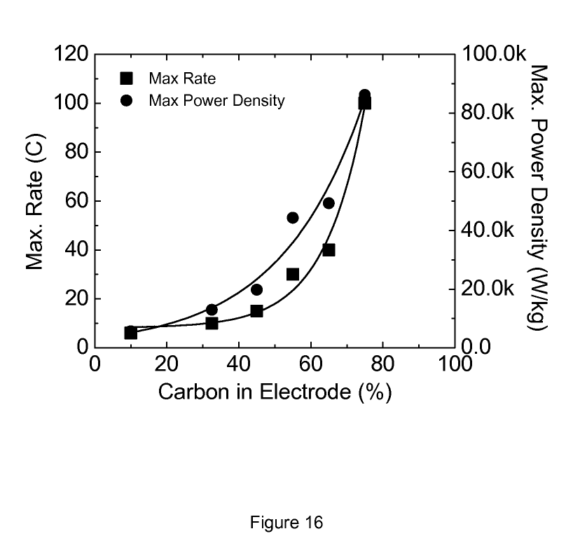

FIG. 16 shows a plot maximum discharge rate and maximum power density versus the percentage of carbon in the electrode. The power density calculations are based on the amount of CF.

### EXAMPLE 3

### Effect Of Carbon Dilution And Densification For Electrodes With CF0.647 Active Material

Three electrodes of CFx (x=0.647) were made and tested with their rechargeable ability. Electrode A: a 75% CFx material without densification. Electrode B: a densified 75% CFx Electrode C: a densified, carbon-diluted 50% CFx electrode. The three electrodes were assembled as 2016 coin cells with Lithium foil anodes. The electrolyte was 1M LiPF6+0.5M LiF in EC/DEC. After initial fully discharged (C/10) to 1.5V, the electrodes were cycled between 2.5V and upper limits at 4.5 to 5V.

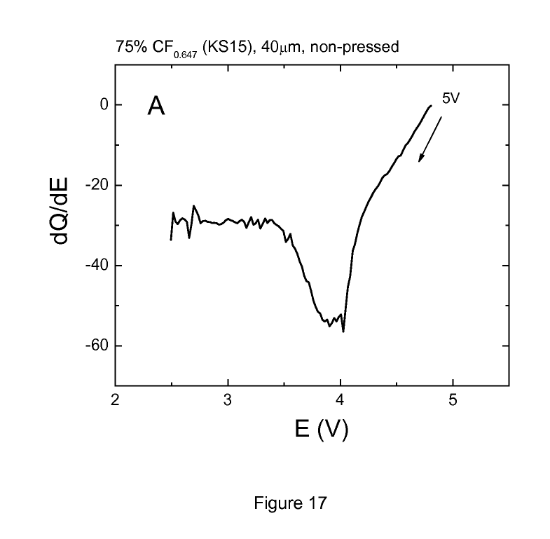

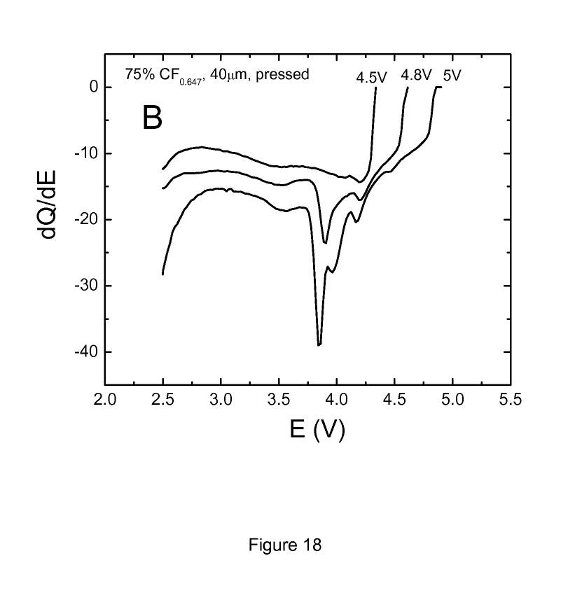

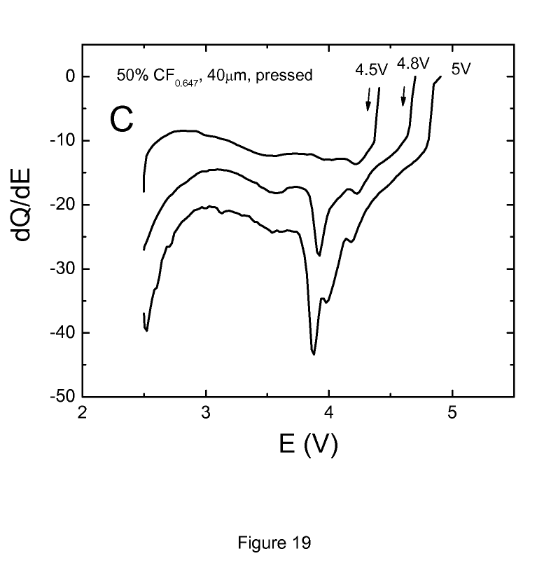

FIG. 17 shows differential capacity versus voltage for Electrode A. The rechargeable cell was charged to 5V prior to discharge. FIG. 18 shows differential capacity versus voltage for Electrode B. The rechargeable cell was charged to 4.5 V, 4.8 V, and 5 V prior to discharge. FIG. 19 shows differential capacity versus voltage for Electrode C. The electrodes with densification and carbon dilution showed better discharge profiles with increased peak currents. Better definition of the discharge plateaus was found in the densified cathodes indicated enhanced kinetics. The incremental capacity curves show sharper discharge peaks at around 4 V. The rechargeable cell was charged to 4.5 V, 4.8 V, and 5 V prior to discharge.

### EXAMPLE 4

### Effect Of Mixing CF1 And CF0.74 Active Material

The CF1 was commercial carbon monofluoride (here PC10 produced by Lodestar, USA). The CFx was sub-fluorinated carbon fluoride (x<1) made by CNRS-CALTECH; the “x” value was 0.74. The cathode compositions were: CF1, CFx or CF1+CFx mixture with conducting carbon black and PTFE binder. The electrolyte was 1M LiBF4 in PC/DME. 2016 lithium coin cells are used for discharge tests.

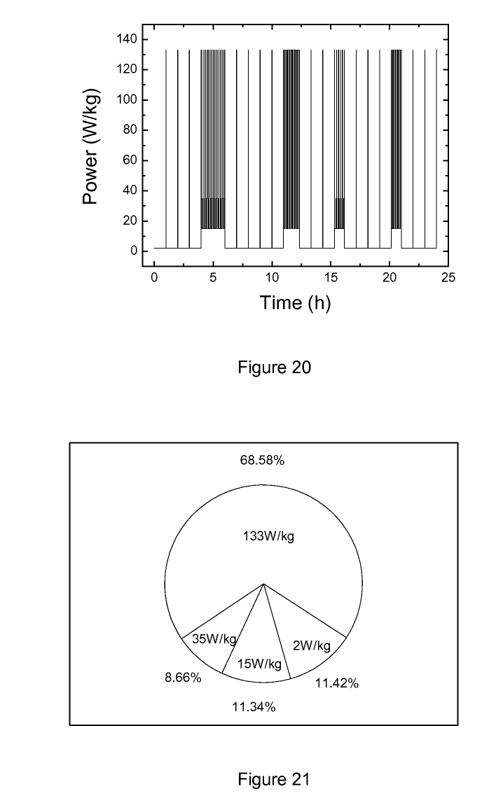

The wearable power test protocol (WPTP) was applied to the Li coin cells. FIG. 20 shows the power profile for the first 24 hours of the WPTP. The 24 hours pattern is repeated 3 times to achieve 96 operation hours. The WPTP consists of sequences of constant power density discharge of: 133 W/kg, 35 W/kg, 15 W/kg and 2 W/kg. The cut-off voltage is 2V; a battery that reaches 2V before 96 hours fails the test. FIG. 21 shows the percent of total energy for each applied discharge power. The major part of consumed energy (68.58%) is achieved at the highest power density of 133 W/kg.

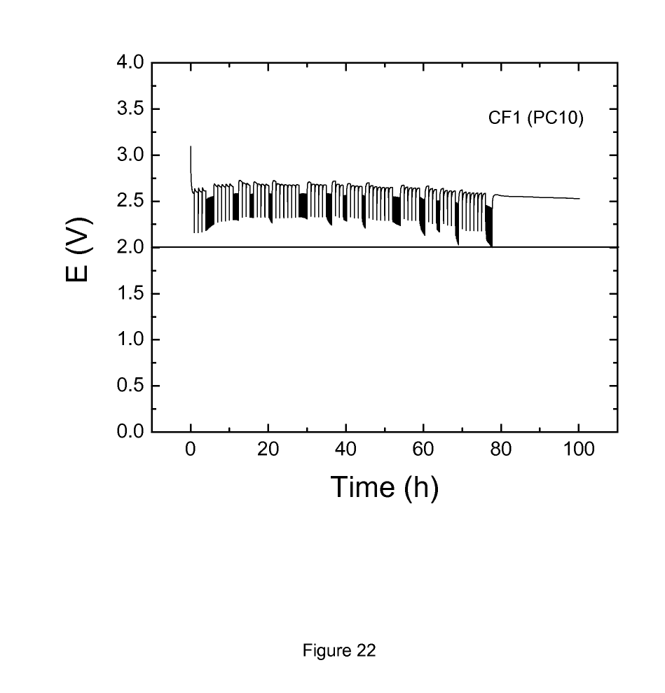

FIG. 22 shows voltage versus time for the cell with a cathode with CF1 active material. The operation time at the 2V cut off was 79 hours; the cell failed the test. CF1 has a low working voltage due to poor conductivity so the test couldn't reach 96 hours.

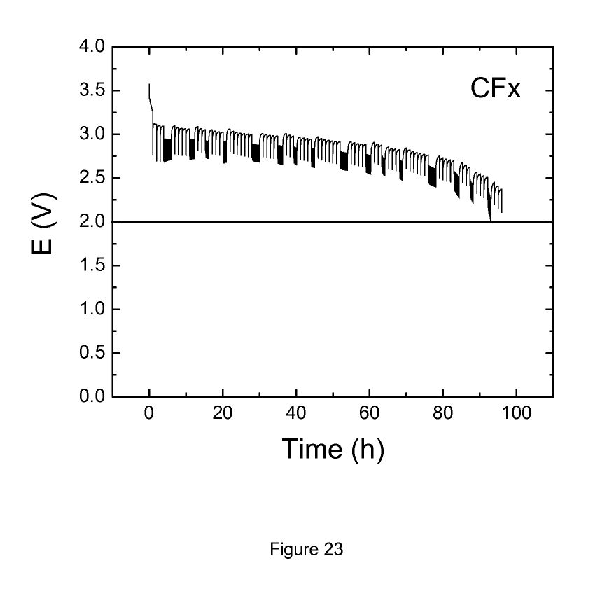

FIG. 23 shows voltage versus time for the cell with a cathode with CFx (x=0.74), active material. The operation time at the 2V cut off was 96 hours; the cell nearly passed the test. Even though this material has a higher average working voltage the voltage at the last test stage dropped quickly. Although CFx has a higher discharge potential and better power capability than CF1, it has less discharge capacity (mAh/g).

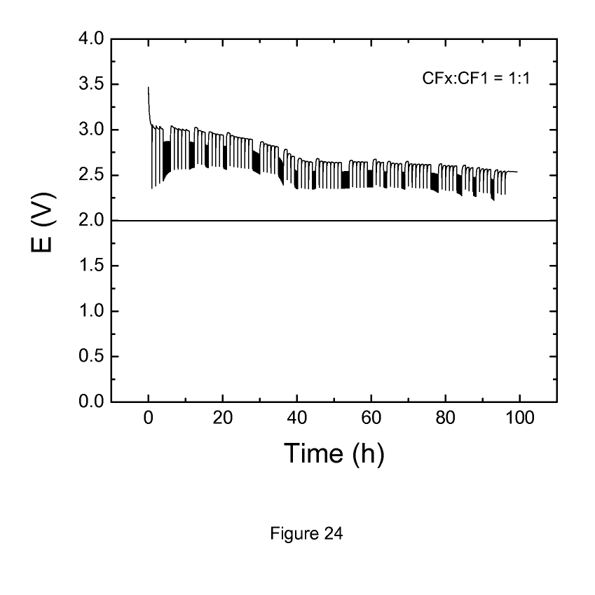

FIG. 24 shows voltage versus time for the cell with the cathode with a weight ratio 1:1 mixture of CF1 and CFx (x=0.74), active material. The operation time at the 2V cut off was 100 hours. The cell passed the test with a flat and stable working profile. The working voltage at the final stage is far above the cutoff 2V. The 2 V cut-off voltage was reached after a longer discharge time under the WPTP. The mixture balances the CF1's high energy density with CFx's high power capability. The load test shows high and stable working voltage. The mixture is a good candidate for cathodes in high energy and high power systems.

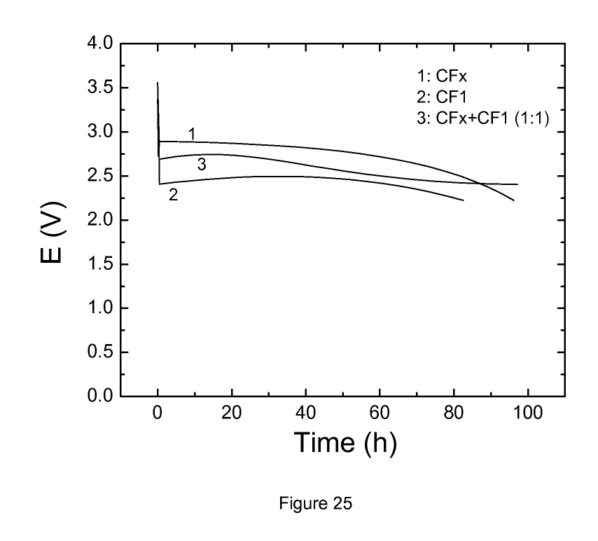

FIG. 25 shows the average working voltage as a function of time for three different cells: 1: CFx (x=0.74); 2: CF1; 3: CF1: CFx with weight ratio=1:1.

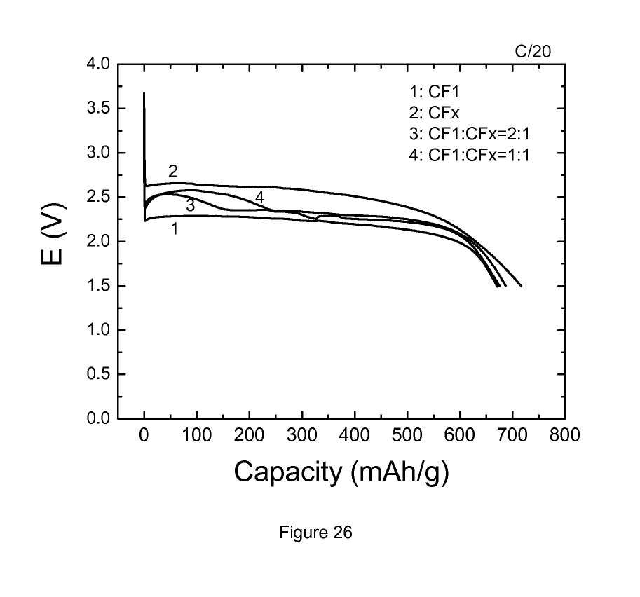

FIG. 26 shows discharge curves at C/20 for four different cells: 1: CF1; 2: CFx (x=0.647); 3: CF1: CFx with weight ratio 2:1, 4: CF1: CFx with weight ratio 1:1. The discharge voltage of the 1:1 mixture is intermediary between that of CF1 and that of CFx. The CFx: CF1 mixture provides a higher discharge voltage than CF1 and a higher capacity than CFx.

### EXAMPLE 5

### Effect Of Carbon Dilution And Densification For Electrodes With CF0.76 Active Material

The carbon fluorides were fluorinated multiwall nanotubes CFx (x=0.76). 2016-type coin cells were made, comprising a CFx cathode and a metallic lithium anode . For the cathode compositions CFx powder and Acetylene Black Graphite (ABG) and PVDF binder were mixed at weight ratios 75:10:15 or 40: 45:15. The 40 wt % material was pressed and predischarged, but the 75 wt % material was not. The CF1 was commercial carbon monofluoride (from coke).

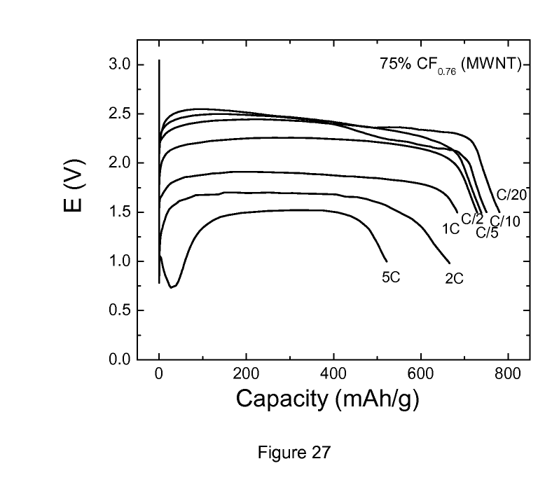

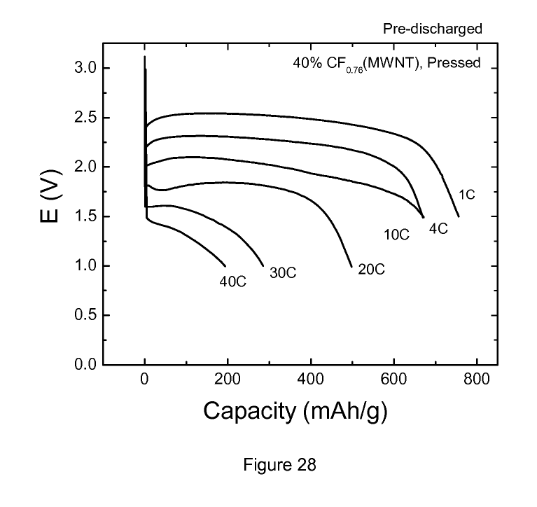

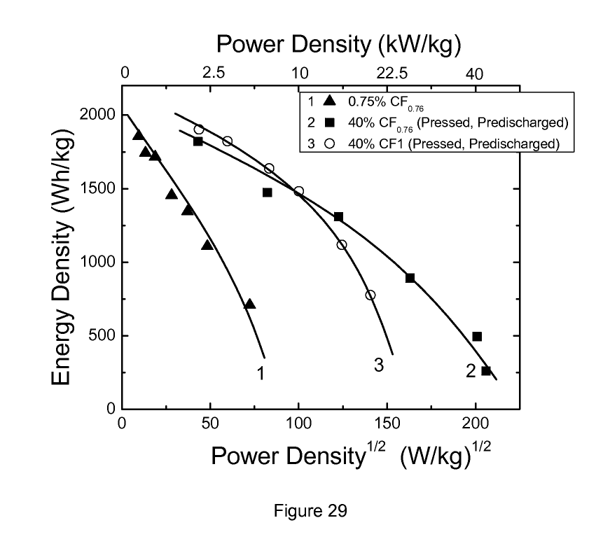

FIG. 27 shows the discharge curves for 75% CFx (x=0.76). FIG. 28 shows the discharge curves for 40% CFx (x=0.76). FIG. 29 shows a Ragone plot comparing 75% CFx (x=0.76), 40% CFx (x=0.76) and 40% CF. In the discharge curves, the capacity is calculated based on the weight of active material. In the Ragone plot, the calculations are also based on the weight of active material

We claim:

1. An electrode composition comprising:
a) a subfluorinated carbonaceous material, wherein the average ratio of fluorine to carbon is greater than 0.5; and
b) an electrically conducting material wherein the subfluorinated carbonaceous material and the electrically conducting material are intermixed, the amount of the subfluorinated carbonaceous material is from 10 wt % to 88 wt %, and the amount of the electrically conducting material is from 12 wt % to 90% wt %, based on the total weight of the subfluorinated carbonaceous material and the electrically conducting material

2. The electrode composition of claim 1, wherein the ratio of the amount of conductive material to the amount of conductive material and subfluorinated carbonaceous material is from 15% to 85%.

3. The electrode composition of claim 1, wherein the electrode composition further comprises from 1 wt % to 20 wt % of a binder material and the amount of the electrically conducting material is greater than 10 wt % based on the total weight of the electrode composition.

4. The electrode composition of claim 3, wherein the amount of the electrically conducting material is greater than or equal to 25 wt % based on the total weight of the electrode composition.

5. The electrode composition of claim 1, wherein the electrically conducting material is a carbonaceous material.

6. An electrode comprising the electrode composition of claim 5, wherein the density of the electrode composition is greater than 1.0 g/cm³.

7. The electrode of claim 6, wherein the density of the electrode composition is greater than or equal to 1.5 g/cm³.

8. An electrochemical cell comprising
a) a first electrode comprising the electrode composition of claim 1;
b) a second electrode comprising lithium or a lithium alloy; and
c) an electrolyte
wherein the first and second electrode are separated.

9. The electrochemical cell of claim 8 after discharge of no more than 10% of the initial capacity of the cell at a rate no greater than C/10 for a period of at least one half hour.

10. An electrode composition comprising
a) a first fluorinated carbonaceous material comprising a subfluorinated carbonaceous material; and
b) a second fluorinated carbonaceous material different from the first fluorinated carbonaceous material;
wherein the first and second fluorinated carbonaceous materials are intermixed and the amount of the first material is from 5 wt % to 95 wt % based on the total weight of the first and second materials.

11. The electrode composition of claim 10, wherein the amount of the first fluorinated carbonaceous material is from 25 wt % to 75 wt %.

12. The electrode composition of claim 10, wherein the average ratio of fluorine to carbon of the subfluorinated carbonaceous material is greater than 0.5.

13. The electrode composition of claim 10, wherein average ratio of fluorine to carbon of the second fluorinated carbonaceous material is greater than or equal to 1.0.

14. The electrode composition of claim 10, wherein the second fluorinated carbonaceous material is C₂F.

15. The electrode composition of claim 10, wherein the second fluorinated carbonaceous material comprises a second subfluorinated carbonaceous material, the average ratios of fluorine to carbon of the two subfluorinated carbonaceous materials are different, and the average ratio of fluorine to carbon of the first subfluorinated carbonaceous material is greater than 0.5.

16. The electrode composition of claim 10, wherein the electrode composition further comprises from 1 wt % to 20 wt % of a binder material based on the total weight of the electrode composition.

17. The electrode composition of claim 10, wherein the electrode composition further comprises an electrically conductive material, the amount of electrically conductive material being from 5 wt % to 50 wt % based on the total weight of the electrode composition.

18. The electrode composition of claim 17, wherein the electrically conducting material is a carbonaceous material.

19. An electrode comprising the electrode composition of claim 10, wherein the density of the electrode composition is greater than 1.0 g/cm³

20. An electrode comprising the electrode composition of claim 19, wherein the density of the electrode composition is greater than or equal to 1.5 g/cm³

21. An electrochemical cell comprising
a) a first electrode comprising the electrode composition of claim 10;
b) a second electrode comprising lithium or a lithium alloy; and
c) an electrolyte
wherein the first and second electrode are separated.

22. The electrochemical cell of claim 21 after discharge of no more than 10% of the initial capacity of the cell at a rate no greater than C/10 for a period of at least one half hour.
